(19) United States
(12) Patent Application Publication
(10) Pub. No.: US 2025/0360756 A1
(43) Pub. Date: Nov. 27, 2025

(54) Puncture Resistant Inner Tube for Pneumatic Tires

(71) Applicant: Joshua Andrew Deetz, Albany, CA (US)

(72) Inventor: Joshua Andrew Deetz, Albany, CA (US)

(21) Appl. No.: 18/672,008

(22) Filed: May 23, 2024

(51) Int. Cl. B60C 5/04

(52) U.S. Cl. CPC B60C 5/04

(57) ABSTRACT

The present invention relates to a puncture resistant inner tube for pneumatic tires. The inventive device comprises an outer tube and at least one inner tube, wherein the cross-sectional circumference of the inner tube is greater than that of the outer tube. This unique design allows the inner tube to move out of the way in the event of a puncture, providing enhanced safety and reliability. By utilizing excess material from the inner tube to create fold-like structures when pressurized, the invention provides a self-compensating mechanism for punctures. The inventive device can be used in various applications, including pneumatic tires, safety devices such as avalanche protection systems, life jackets, and other containers that require puncture resistance.

### TECHNICAL FIELD

The present invention generally relates to the field of wheels for vehicles, and more particularly to inner tubes for use with pneumatic tires.

### BACKGROUND OF THE INVENTION

Pneumatic tires have been a ubiquitous feature of modern vehicles for over a century, providing cushioning, traction, and stability on various road surfaces. However, despite their widespread adoption, punctures caused by sharp objects such as nails, glass, or metal debris remain a significant concern. The consequences of a puncture can be severe, including reduced tire performance, costly repairs, and increased risk of accidents.

Various solutions have been proposed to address the problem of tire punctures. Tire sealants, for example, are designed to fill small holes in the tire casing and prevent air loss. However, these products often require periodic maintenance and may not provide adequate protection against larger punctures or punctures that occur on the tire sidewall. Foam tire inserts have also been developed as a means of solving the issue of punctures but add significant weight and may compromise tire handling and performance.

These solutions often come with significant drawbacks, including added weight and limited success in preventing air loss. Moreover, some of these solutions may not be suitable for all types of tires or driving conditions. Therefore, there remains a need for a more effective and efficient means of preventing air loss in the event of a tire puncture that does not compromise tire performance or handling.

The present invention addresses this need by providing a puncture-resistant inner tube for pneumatic tires that offers improved protection against punctures while minimizing weight and cost.

### SUMMARY OF THE INVENTION

The present invention relates to a puncture resistant inner tube for pneumatic tires. The inventive design provides a means by which an object that punctures the outer layer of the inner tube will be unable to reach the inner pressurized layers. This is achieved through the creation of excess material within the inner layers, allowing them to move out of the way in response to pressure caused by a puncture.

The inventive design comprises a plurality of nested tubes, including an outer tube and at least one inner tube. The cross-sectional circumference of the inner tube(s) is greater than that of the outer tube. This excess material creates fold-like structures when the inner tube is pressurized which are facilitated by the internal pressure to move around any object that may puncture the outer layer thereby minimizing the risk of loss of pressure in the inner tube.

### BRIEF DESCRIPTION OF DRAWINGS

In the following detailed portion of the present description, the teachings of the present application will be explained in more detail with reference to the example embodiments shown in the drawings, in which:

FIG. 1 is a side view of a generally toroidal shaped first embodiment of the invention provided with a valve.

FIG. 2 is a side view of a generally straight shaped second embodiment of the invention provided with a valve.

FIG. 3 is a perspective cross-sectional view of a portion of the invention mounted inside of a tire on a rim of a wheel according to the first embodiment.

FIG. 3A is simplified version of FIG. 3 in which the perspective lines have been removed to clearly show the configuration of the invention.

FIG. 4 is a simplified cross-sectional view of the invention without perspective lines.

FIG. 4A is a diagram showing the relative cross-sectional lengths of the components of the invention.

FIG. 5 is a simplified cross-sectional view of the invention without perspective lines.

FIG. 5A is a version of FIG. 4 showing the invention provided with a valve.

FIG. 6 is a simplified cross-sectional view of the invention without perspective lines.

### DETAILED DESCRIPTION

In the following detailed description, the puncture resistant inner tube according to the teachings for this application in the form of a nested tube structure will be described by the embodiments. It should be noted that although only a bicycle wheel inner tube is described, the teachings of this application can also be used in any other pneumatic tire such as automobile tires, airplane tires or in applications requiring puncture resistant retention of gas or fluids such as personal avalanche protection systems, motorcycle airbag protection systems, personal flotation devices, or fuel bladders.

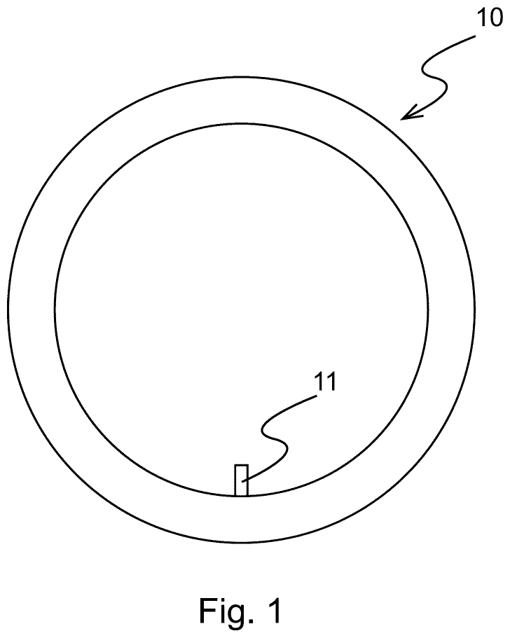

FIG. 1 illustrates a side view of a first embodiment of the invention. In this embodiment the puncture resistant inner tube 10 is generally toroidal in shape. FIG. 1 also shows the first embodiment of the invention with a valve 11. The valve 11 may be of any type such as a Schrader, presta, or Dunlop style valves, but may include other configurations of valve that permit the pressurization of the puncture resistant inner tube 10. The invention can be understood to also operate without the use of a valve 11. Such configurations could be achieved through pressurization of the puncture resistant inner tube 10 at the time of manufacture or pressurization through the use of gas producing devices, such as gas cartridges or chemical reactions, located inside of the puncture resistant inner tube 10.

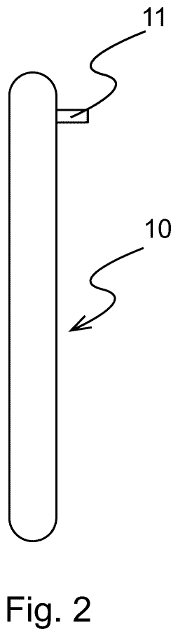

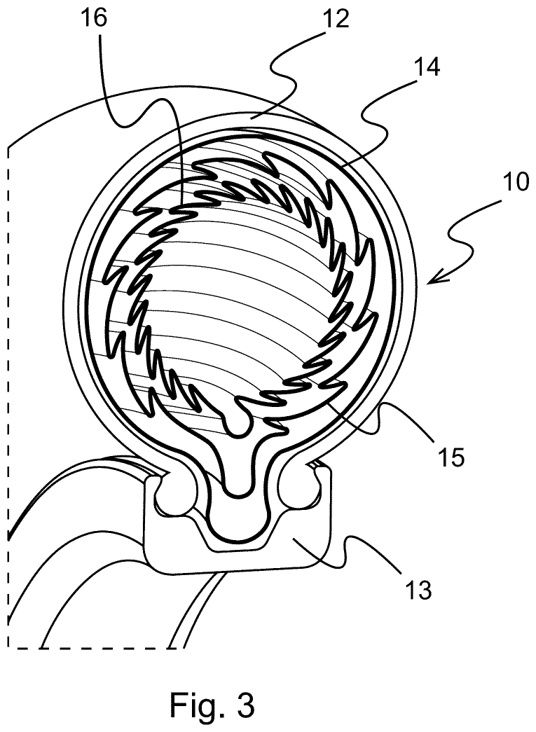

FIG. 2 illustrates a side view of a second embodiment of the invention. The puncture resistant inner tube 10 shown in this figure is molded into a generally straight shape. FIG. 2 also shows the second embodiment of the invention with a valve 11. The valve may be anywhere on the puncture resistant inner tube 10 depending on the application. This second embodiment allows the puncture resistant inner tube 10 to be installed inside a tire and affixed in place by securing the two ends together or by affixing to features in a tire or wheel rim. This second embodiment of the invention may simplify manufacture of the puncture resistant inner tube 10 and thereby reduce cost.

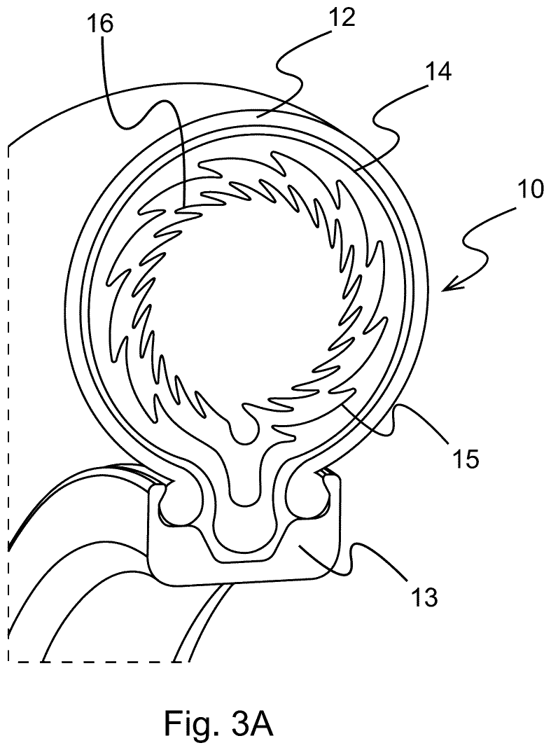

FIG. 3 is a perspective cross-sectional view of a portion of the invention mounted inside of a tire 12 on a rim 13 of a wheel. The invention comprises a plurality of nested tubes comprising an outer tube 14 and at least one inner tube 15. FIG. 3 further depicts an additional layer of inner tube 16. FIG. 3A is simplified version of FIG. 3 in which the perspective lines have been removed to clearly show the relative positioning of the outer tube 14 and inner tube 15, as well as any additional inner tube 16 layers that may be required depending on the use case of the invention. It can be understood that the invention comprises an outer tube 14 and at least one inner tube 15. The cross-sectional circumference of the inner tube 15 is greater than the cross-sectional circumference of the outer tube 14. While it is preferable that each axially interior layer of inner tube have a greater cross-sectional circumference than the layer surrounding said layer, it can be understood that any additional layers need not follow the relationship of the cross-sectional circumference of the said layer being less than the cross-sectional circumference of the of inner tube 15. In other words, the present invention discloses a puncture resistant inner tube 10 with an outer layer with a cross-sectional circumference less than at least one inner layer disposed axially inward of said outer layer. It is further understood that the outer layer may be formed by or integrated into a casing such as a tire 12, garment, or bag. Further, the outer tube 14 and inner tube 15 need not be comprised of the same materials. One aspect of the invention is the characteristic of the inner tube 15 having additional material in comparison to the outer tube 14 to permit the inner tube 15 to move out of the way of an object in the event said object punctures the outer tube 14. To facilitate this movement, the inner tube 15 may be comprised of a low friction material or coating such as polyester film, polyethylene sheet, thermo plastics, or Teflon. Further, a low friction medium such as talc may be added between the layers to aid in the movement of the inner tube 15.

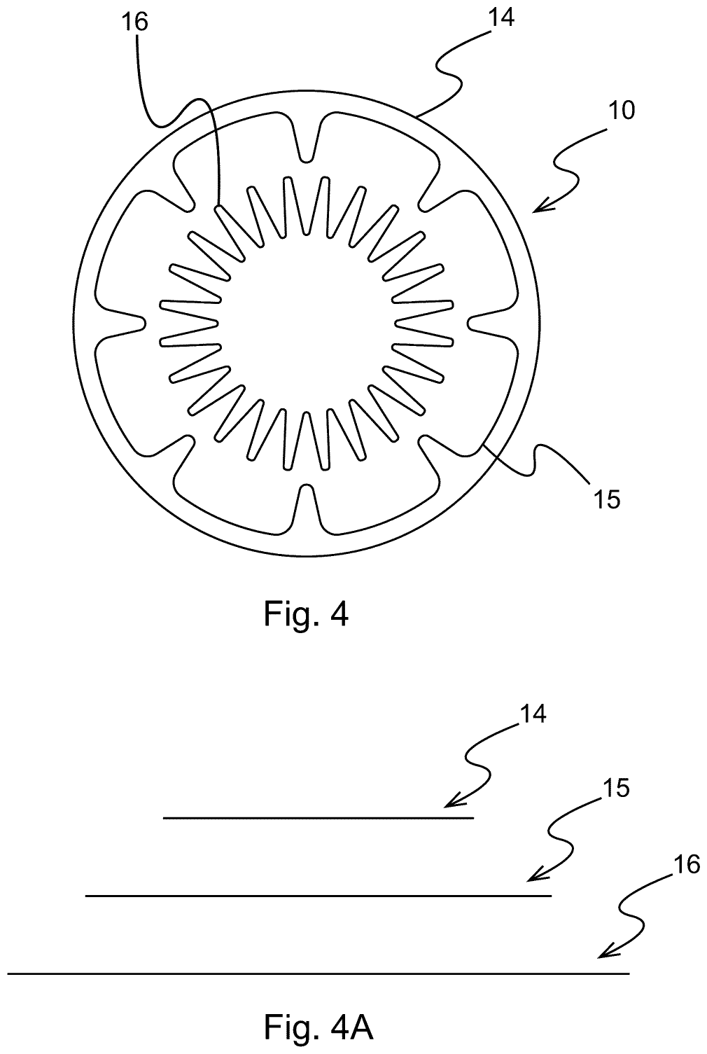

FIG. 4 is a simplified cross-sectional view of the invention without perspective lines. FIG. 4A is a diagram showing the relative cross-sectional lengths of the components of the invention transposed as straight lines. By displaying the relative cross-sectional lengths of the layers as straight lines, a feature of this invention can be more easily understood. FIG. 4A shows that the cross-sectional length of the outer tube 14 is less than that of the cross-sectional length of the inner tube 15 and any additional layers, such as inner tube 16 shown in FIG. 4. The invention requires that at least one layer that is surrounded by the outer tube 14 have a greater cross-sectional length than said outer tube 14.

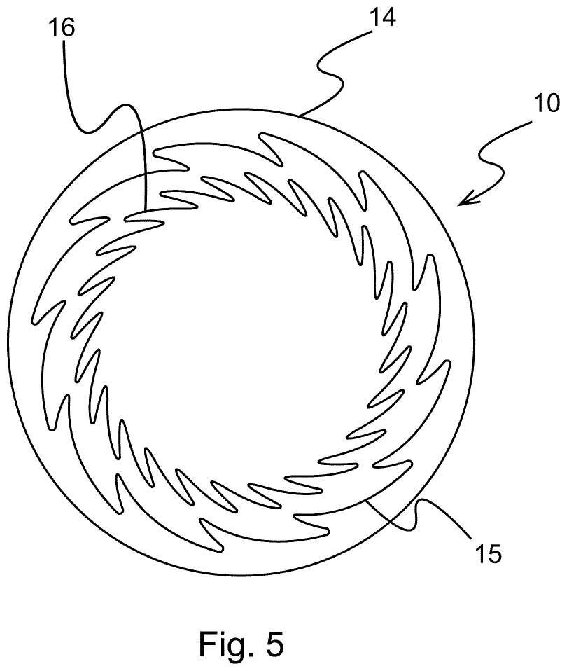

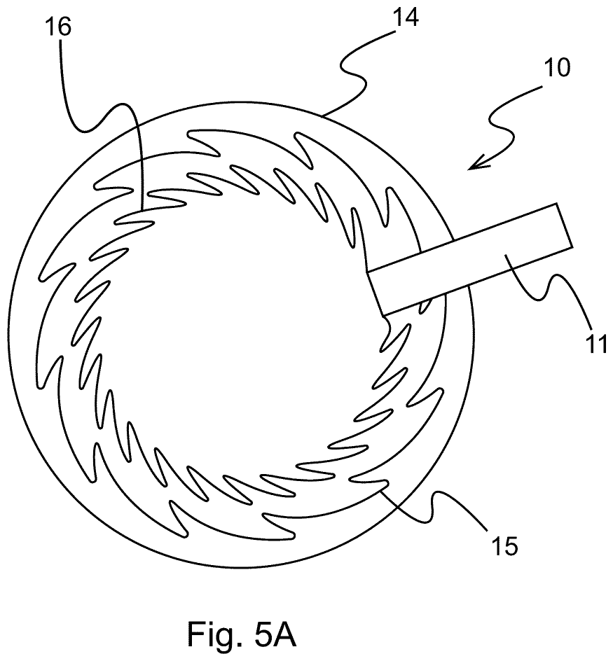

FIG. 5 is a simplified cross-sectional view of the invention without perspective lines showing that the excess material of the inner tube 15 creates at least one fold like structure when the puncture resistant inner tube 10 is pressurized. Further, FIG. 5A is a version of FIG. 5 showing the invention provided with a valve 11. The valve 11 permits the addition of air or liquids into the inner chamber of the invention. In the event that an object punctures the outer tube 14, the pressure contained within the inner layers, i.e. inner tube 16 as shown in FIG. 4A, will facilitate the movement of said inner layers around said object.

A further embodiment of the invention includes a two or more layers nested within one another. When pressurized, at least one inner layer is characterized by having at least one fold. As such the inventor has discovered that the fold of inner layer is not under tension when the puncture resistant inner tube is inflated thereby allowing said inner layer to move or deform around any object that punctures the outer layer.

1. A puncture resistant inner tube for a tire comprising:
a plurality of nested tubes comprising:
an outer tube;
at least one inner tube;
wherein each said inner tube is nested within another tube and each said inner tube has a cross-sectional circumference greater than the cross-sectional circumference of the tube in which it is nested.

2. The invention of claim 1, wherein the cross-sectional circumference of said inner tube is not under tension when the puncture resistant inner tube is pressurized.

3. The invention of claim 1, wherein a low friction medium is provided between said nested tubes.

4. The invention of claim 1, wherein said inner tube is comprised of a low friction material.

5. The invention of claim 1, further comprising a valve configured to pressurize the innermost tube of said nested tubes.

6. A puncture resistant inner tube for a tire, comprising:
two or more layers;
wherein said layers are disposed such that the arrangement of any two layers define an axially inward layer and an axially outward layer such that the axial circumference of said outward layer is less than the axial circumference of said inward layer.

7. The invention of claim 6, wherein the cross-sectional circumference of said layer is not under tension when the puncture resistant inner tube is pressurized.

8. The invention of claim 6, wherein a low friction medium is provided between said layers.

9. The invention of claim 6, wherein one or more of said layer is comprised of a low friction material.

10. The invention of claim 6, further comprising a valve configured to pressurize the cavity defined by the layer disposed most axially inward of said layers.

11. A puncture resistant inner tube for a tire, comprising:
a plurality of layers comprising:
an outer layer;
at least one inner layer axially disposed inside of said outer layer;
wherein said inner layer is characterized by having one or more folds when the puncture resistant inner tube is pressurized.

12. The invention of claim 11, wherein the cross-sectional circumference of said inner layer is not under tension when the puncture resistant inner tube is pressurized.

13. The invention of claim 11, wherein a low friction medium is provided between said layers.

14. The invention of claim 11, wherein one or more of said layer is comprised of a low friction material.

15. The invention of claim 11, further comprising a valve configured to pressurize the cavity defined by the layer disposed most axially inward.
